(19) United States
(12) Patent Application Publication
(10) Pub. No.: US 2015/0262042 A1
(43) Pub. Date: Sep. 17, 2015

(54) INFORMATION PROCESSING APPARATUS, INFORMATION PROCESSING SYSTEM, INFORMATION PROCESSING METHOD, AND STORAGE MEDIUM

(71) Applicant: FUJI XEROX CO., LTD, Tokyo (JP)

(72) Inventor: Satoshi WATANABE, Kanagawa (JP)

(73) Assignee: FUJI XEROX CO., LTD, Tokyo (JP)

(21) Appl. No.: 14/472,796

(22) Filed: Aug. 29, 2014

(30) Foreign Application Priority Data
Mar. 14, 2014 (JP) 2014-052238

(51) Int. Cl. G06K 15/02; G06F 3/12

(52) U.S. Cl. CPC G06K 15/1806; G06F 3/1237; G06F 3/1285

(57) ABSTRACT

An information processing apparatus includes an acquiring unit that acquires a first instruction and a second instruction, the second instruction corresponding to the first instruction, being expressed in a character code different from a character code of the first instruction, and having added thereto a character string generated from the first instruction; a generating unit that generates a character string from the first instruction; and a canceling unit that cancels the second instruction if the character string added to the second instruction does not correspond to the character string generated by the generating unit.

### CROSS-REFERENCE TO RELATED APPLICATIONS

This application is based on and claims priority under 35 USC 119 from Japanese Patent Application No. 2014-052238 filed Mar. 14, 2014.

### BACKGROUND

The present invention relates to an information processing apparatus, an information processing system, an information processing method, and a storage medium.

### SUMMARY

According to an aspect of the invention, there is provided an information processing apparatus including an acquiring unit that acquires a first instruction and a second instruction, the second instruction corresponding to the first instruction, being expressed in a character code different from a character code of the first instruction, and having added thereto a character string generated from the first instruction; a generating unit that generates a character string from the first instruction; and a canceling unit that cancels the second instruction if the character string added to the second instruction does not correspond to the character string generated by the generating unit.

### BRIEF DESCRIPTION OF THE DRAWINGS

An exemplary embodiment of the present invention will be described in detail based on the following figures, wherein:

FIG. 1 illustrates a general configuration of an image processing system;

FIG. 2 is a block diagram showing a functional configuration of a PC;

FIG. 3 is a block diagram showing a functional configuration of an image forming apparatus;

FIG. 4 is a block diagram showing a hardware configuration of the PC;

FIG. 5 is a block diagram showing a hardware configuration of a server apparatus;

FIG. 6 is a block diagram showing a hardware configuration of the image forming apparatus;

FIG. 7 is a flowchart showing processing of transmitting a job control command;

FIG. 8 illustrates an example of the job control command;

FIG. 9 illustrates an example overview of processing of re-writing the job control command;

FIG. 10 illustrates a specific example of the processing of re-writing the job control command;

FIG. 11 is a flowchart showing processing of acquiring the job control command;

FIG. 12 illustrates an example of a job control command according to a first modification; and

FIG. 13 illustrates an example of a job control command according to a twelfth modification.

### DETAILED DESCRIPTION

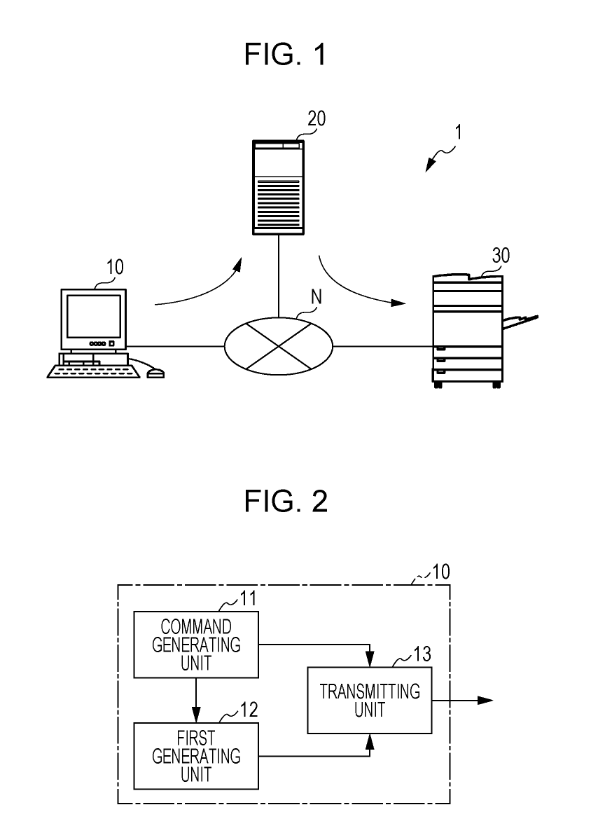

FIG. 1 illustrates a general configuration of an image processing system 1 according to an exemplary embodiment of the invention. The image processing system 1 (example of information processing system) executes various information processing relating to image data. The image processing system 1 includes a personal computer 10 (hereinafter, referred to as “PC 10”), a server apparatus 20, and an image forming apparatus 30. The PC 10 is an information processing apparatus that transmits a command (instruction) to the image forming apparatus 30. To entirely manage the use of the image forming apparatus 30, the image forming apparatus 30 is set to accept only a command from a specific apparatus (in this example, server apparatus 20). Hence, the PC 10 transmits a command for the image forming apparatus 30 to the server apparatus 20. The server apparatus 20 relays the command transmitted from the PC 10 to the image forming apparatus 30.

The command transmitted by the PC 10 includes a command described in a language (page description language) for instructing rendering (hereinafter, referred to as “rendering command”), and a command described in a language (job control language) for indicating additional information, such as the creator and name of a document rendered in the page description language and authentication information relating to the authority to use the image forming apparatus 30 (hereinafter, referred to as “job control command.” In the example of FIG. 1, for the job control language, the PC 10 supports a first character code and a second character code different from the first character code. The first character code is adoptable to a single language such as Shift JIS. Hereinafter, the first character code is expressed as “non-extended character code.” The second character code is adoptable to multiple languages such as Unicode. Hereinafter, the second character code is expressed as “extended character code.”

The server apparatus 20 (example of external apparatus) manages execution of a command in the image forming apparatus 30. The server apparatus 20 relays the rendering command and the job control command acquired from the PC 10 to the image forming apparatus 30. In FIG. 1, the server apparatus 20 re-writes at least a partial job control command among plural job control commands acquired from the PC 10 in order to cause the image forming apparatus 30 to execute the command. For example, if the image forming apparatus 30 is set to execute only a command in which a specific user name is described in a job control command, and if a user name described in a job control command acquired from the PC 10 is not the specific user name, the server apparatus 20 re-writes the user name into the specific user name. Accordingly, if a user having a user name, with which the command is not expected to be executed in the image forming apparatus 30, attempts to use the image forming apparatus 30, the specific user name is used and the command is executed. For another example, if the image forming apparatus 30 is set to execute only a command, in which a document name with a predetermined number of characters or less is described in a job control command, and if a document name with a number of characters more than the predetermined number of characters is described in a job control command acquired from the PC 10, the server apparatus 20 re-writes the document name into a document name with the predetermined number of characters or less. Accordingly, if a job control command having described therein a document name, with which the command is not expected to be executed in the image forming apparatus 30, is acquired from the PC 10, the command is executed with the document name with the predetermined number of characters or less. It is to be noted that data for re-writing the job control command (for example, data indicative of correspondence between job control commands before and after re-writing) is stored in the server apparatus 20, and the server apparatus 20 re-writes the job control command in accordance with the data. In the example in FIG. 1, the server apparatus 20 supports the non-extended character code, and does not support the extended character code.

The image forming apparatus 30 is an information processing apparatus that functions as a copier, a printer, a scanner, a facsimile, etc. The image forming apparatus 30 executes the rendering command and the job control command acquired from the server apparatus 20. In the example in FIG. 1, the image forming apparatus 30 supports both the non-extended character code and the extended character code. The PC 10, the server apparatus 20, and the image forming apparatus 30 are mutually connected through a communication line N such as the Internet.

In the image processing system 1 shown in FIG. 1, a problem may occur as follows. Now, the following situation is considered. The PC 10 transmits plural job control commands described in the extended character code to the server apparatus 20. Since the server apparatus 20 does not support the extended character code, the server apparatus 20 re-writes at least a partial command among plural job control commands acquired from the PC 10 into a command described in the non-extended character code, and outputs the re-written job control command to the image forming apparatus 30. The image forming apparatus 30 reads the plural job control commands acquired from the server apparatus 20 in the form of the extended character code. In this case, since the plural job control commands include the job control command described in the non-extended character code, if the job control command is read in the form of the extended character code, a malfunction (in other words, garbling) occurs. The image processing system 1 prevents a malfunction from occurring in the image forming apparatus 30 if a job control command is transmitted through the server apparatus 20 that does not support the extended character code. Hereinafter, the job control command described in the non-extended character code is expressed as “first command,” and the job control command described in the extended character code is expressed as “second command.”

FIG. 2 is a block diagram showing a functional configuration of the PC 10. The PC 10 includes a command generating unit 11, a first generating unit 12, and a transmitting unit 13. The command generating unit 11 generates a first command and a second command corresponding to the first command. The first generating unit 12 generates a character string from the first command. The character string is specific data derived by executing a predetermined calculation on an original command. The same character string is generated from the same command, and different character strings are generated from different commands. The transmitting unit 13 transmits the first command and the second command having added thereto the character string generated by the first generating unit 12.

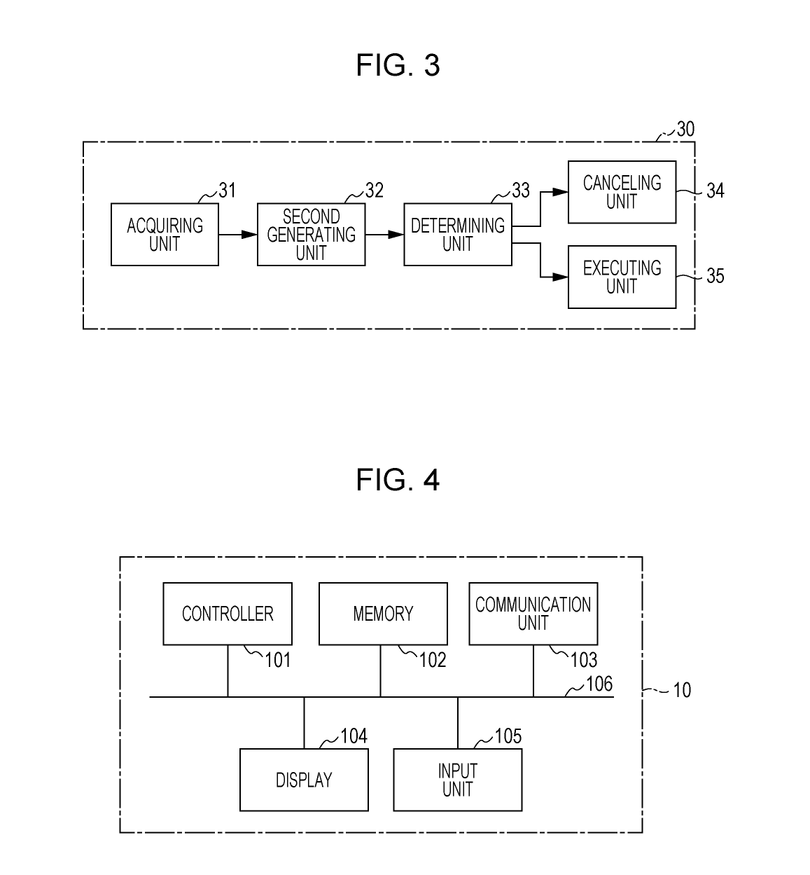

FIG. 3 is a block diagram showing a functional configuration of the image forming apparatus 30. The image forming apparatus 30 includes an acquiring unit 31, a second generating unit 32, a determining unit 33, a canceling unit 34, and an executing unit 35. The acquiring unit 31 acquires a first command and a second command. The second generating unit 32 generates a character string from the first command. The determining unit 33 determines whether or not a character string added to the second command corresponds to the character string generated by the second generating unit 32. The canceling unit 34 cancels the second command and executes the first command if it is determined that the character string added to the second command does not correspond to the character string generated by the second generating unit 32. It is to be noted that “canceling” mentioned here represents a situation in which the acquired second command is not executed, and may include a situation in which the second command is not deleted. The executing unit 35 executes the second command if it is determined that the character string added to the second command corresponds to the character string generated by the second generating unit 32.

FIG. 4 is a block diagram showing a hardware configuration of the PC 10. As shown in FIG. 4, the PC 10 is a computer including a controller 101, a memory 102, a communication unit 103, a display 104, and an input unit 105. Also, the respective units of the PC 10 are connected with a bus 106, and transmit and receive various data through the bus 106.

The controller 101 controls operations of the respective units of the PC 10. The controller 101 includes an arithmetic processing unit such as a central processing unit (CPU), and a recording medium (main memory), such as a read only memory (ROM), a random access memory (RAM), etc. The memory 102 stores data. The memory 102 includes a recording medium (auxiliary memory), such as a hard disk, a flash memory, etc., and stores data received by the communication unit 103. The communication unit 103 transmits and receives data. The communication unit 103 is connected with the communication line N, and functions as a communication interface that makes communication with other apparatus connected with the communication line N. The display 104 displays information, and is, for example, a liquid crystal display. The input unit 105 accepts an input by a user, and includes a keyboard, a mouse, and various buttons.

In FIG. 4, the controller 101 that executes a program is an example of the command generating unit 11 and the first generating unit 12. The communication unit 103 controlled by the controller 101 that executes the program is an example of the transmitting unit 13.

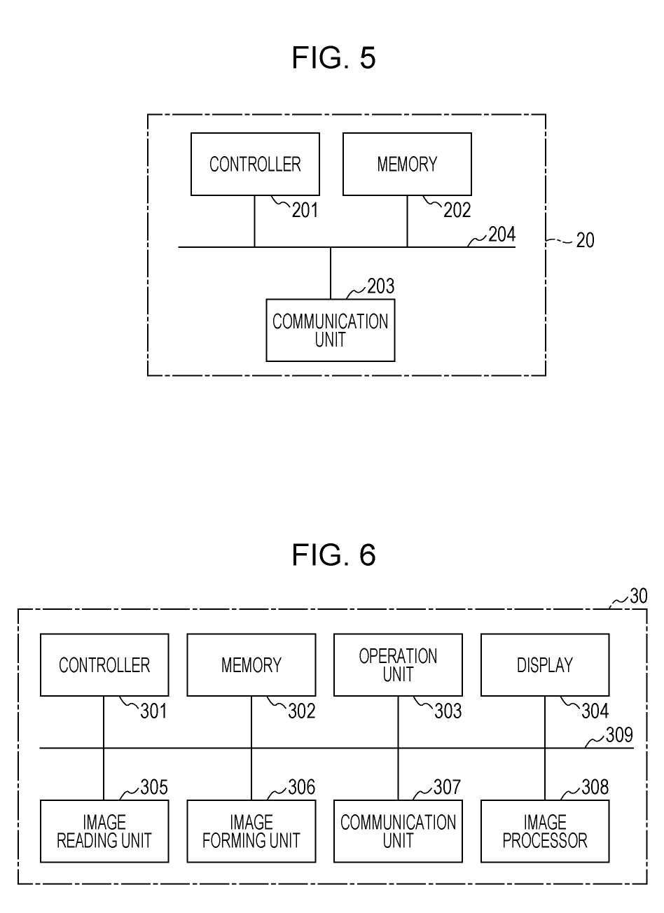

FIG. 5 is a block diagram showing a hardware configuration of the server apparatus 20. As shown in FIG. 5, the server apparatus 20 is a computer including a controller 201, a memory 202, and a communication unit 203. Also, the respective units of the server apparatus 20 are connected with a bus 204, and transmit and receive various data through the bus 204.

The controller 201 controls operations of the respective units of the server apparatus 20. The controller 201 includes an arithmetic processing unit such as a CPU, and a recording medium (main memory), such as a ROM, a RAM, etc. The memory 202 stores data. The memory 102 includes a recording medium (auxiliary memory), such as a hard disk, a flash memory, etc., and stores data received by the communication unit 203. The communication unit 203 transmits and receives data. The communication unit 203 is connected with the communication line N, and functions as a communication interface that makes communication with other apparatus connected with the communication line N.

FIG. 6 is a block diagram showing a hardware configuration of the image forming apparatus 30. As shown in FIG. 6, the image forming apparatus 30 includes a controller 301, a memory 302, an operation unit 303, a display 304, an image reading unit 305, an image forming unit 306, a communication unit 307, and an image processor 308. Also, the respective units of the image forming apparatus 30 are connected with a bus 309, and transmit and receive various data through the bus 309.

The controller 301 controls operations of the respective units of the image forming apparatus 30. The controller 301 includes an arithmetic processing unit such as a CPU, and a recording medium (main memory), such as a ROM, a RAM, etc. The CPU reads a program stored in the ROM, uses the RAM as a work area, and hence executes the program. The controller 301 forms an image on a sheet, reads a document and generates image data of the document, and makes communication with other apparatus through the communication line N, by executing the program as described above.

The memory 302 stores data. The memory 302 includes a recording medium (auxiliary memory), such as a hard disk, a flash memory, etc., and stores data received by the communication unit 307 and data generated by the image forming apparatus 30. Also, the memory 302 may include an attachable/detachable recording medium (removable medium), such as a memory card, a universal serial bus (USB), etc., and a unit that reads and writes data from and to the recording medium.

The operation unit 303 accepts an operation of a user. The operation unit 303 includes an operator (button, key, etc.) and supplies a control signal in accordance with the depressed operator to the controller 301. Alternatively, the operation unit 303 may be formed of a touch panel including the display 304 and a sensor overlaid on the display surface of the display 304, and being configured to supply a control signal in accordance with the depressed position to the controller 301.

The display 304 displays information. The display uses, for example, a liquid crystal display as a display device. The display 304 displays a menu screen for operating the image forming apparatus 30, and data relating to the image forming apparatus 30, under the control of the controller 301.

The image reading unit 305 reads a document and converts the result into image data. The image reading unit 305 includes an image reading device that optically reads a document and generates image data indicative of an image of the read document. The image reading unit 305 supplies the generated image data to the image processor 308.

The image forming unit 306 forms an image. The image forming unit 306 includes an image forming mechanism that forms a toner image on a recording medium such as paper by using an electrophotographic system. The image forming mechanism may not use the electrophotographic system, and may use other recording system such as an inkjet system.

The communication unit 307 transmits and receives data. The communication unit 307 is connected with the communication line N, and functions as a communication interface that makes communication with other apparatus connected with the communication line N.

The image processor 308 executes image processing on image data. Image processing mentioned here is, for example, color correction and gradation correction. The image processor 308 supplies image data after the image processing to the image forming unit 306.

In FIG. 6, the communication unit 307 controlled by the controller 301 that executes the program is an example of the acquiring unit 31. The controller 301 that executes the program is an example of the second generating unit 32, the determining unit 33, the canceling unit 34, and the executing unit 35.

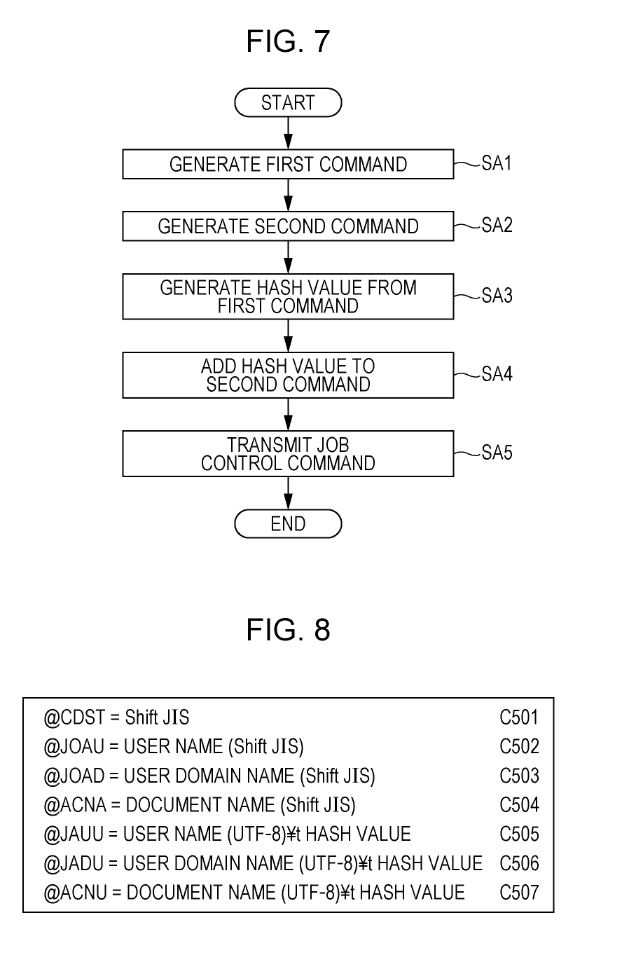

FIG. 7 is a flowchart showing processing in which the PC 10 transmits a job control command. In FIG. 7, the PC 10 has previously installed therein a program (driver) for controlling the image forming apparatus 30. In the driver, an algorithm for generating a hash value (example of character string) is defined from the first command. The processing described below is started in response to input of an instruction for using a function provided by the image forming apparatus 30 (hereinafter, referred to as “use instruction”) to the PC 10. The use instruction is input, for example, when a user operates the input unit 105. The PC 10 transmits the rendering command to the image forming apparatus 30 by processing (not shown) different from the processing shown in FIG. 7.

In step SA1, the controller 101 generates at least one first command in accordance with the function of the image forming apparatus 30 to be used. The controller 101 stores the generated first command in the RAM. In step SA2, the controller 101 generates at least one second command corresponding to the generated first command. The controller 101 stores the generated second command in association with the first command, which serves as an original of the second command, in the RAM. In step SA3, the controller 101 generates a hash value from each first command stored in the RAM. In step SA4, the controller 101 adds the generated hash value to the corresponding second command. To be specific, the controller 101 adds the hash value generated from the first command to the second command corresponding to the first command. The controller 101 stores the second command having the hash value added thereto, in the RAM again. In step SA5, the controller 101 successively transmits plural job control commands to the server apparatus 20. To be specific, the controller 101 reads each first command and each second command from the RAM, and successively transmits the commands to the server apparatus 20.

FIG. 8 illustrates an example of a job control command that is transmitted by the PC 10. In the example in FIG. 8, the PC 10 supports Shift JIS as the non-extended character code, and supports UTF-8 (one of standards for encoding Unicode) as the extended character code. In FIG. 8, the PC 10 transmits seven job control commands including commands C501 to C507. The commands C501 to C504 are each the first command described in Shift JIS. The command C501 is for designating a character code. In this example, Shift JIS is designated. The command C502 is for designating a user name. The command C503 is for designating a user domain name. The command C504 is for designating a document name.

The commands C505 to C507 are each the second command described in UTF-8. In the example in FIG. 8, the second command is transmitted after the first command. The command C505 is for designating a user name. The command C505 corresponds to the command C502, and has a hash value generated from the command C502 added thereto. “Commands corresponding to each other” mentioned here represents that two commands have corresponding meanings (for example, the same meaning). Alternatively, corresponding commands may indicate different meanings. The command C506 is for designating a user domain name. The command C506 corresponds to the command C503, and has a hash value generated from the command C503 added thereto. The command C507 is for designating a document name. The command C507 corresponds to the command C504, and has a hash value generated from the command C504 added thereto.

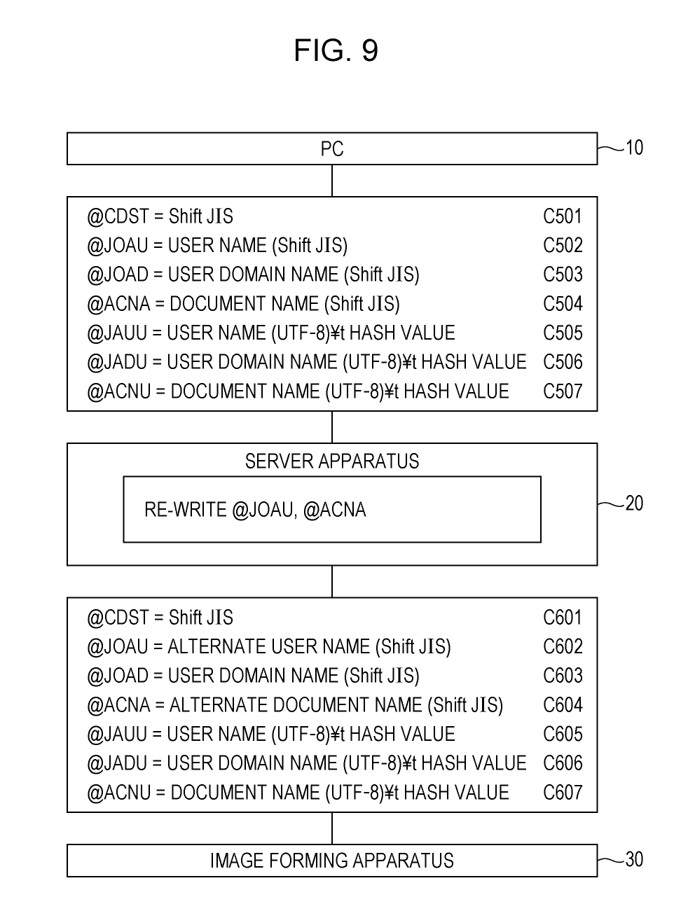

FIG. 9 illustrates an example overview of processing in which the server apparatus 20 re-writes the job control command. FIG. 9 illustrates a state in which the commands C501 to C507 shown in FIG. 8 are input to the server apparatus 20, and commands C601 to C607 are output from the server apparatus 20. In FIG. 9, the server apparatus 20 supports Shift JIS, and does not support UTF-8. In the example in FIG. 9, the server apparatus 20 re-writes the commands C502 and C504, and transmits re-written commands C602 and C604 to the image forming apparatus 30. To be specific, the user name designated in the command C502 is re-written into other user name (alternate user name), and the document name designated in the command C504 is re-written into other document name (alternate document name). Also, the server apparatus 20 transmits the commands C601, C603, C605, C606, and C607 to the image forming apparatus 30 without re-writing the commands C501, C503, C505, C506, and C507. In this example, since the server apparatus 20 does not support the command C503, the user domain name designated in the command C503 is not re-written.

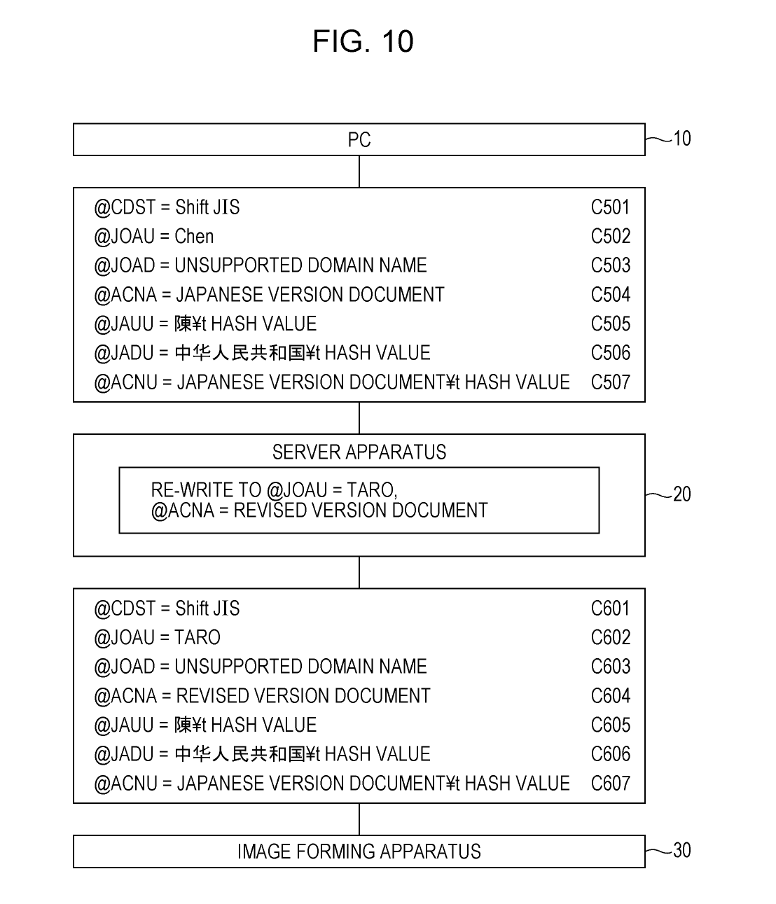

FIG. 10 illustrates a specific example of processing in which the server apparatus 20 re-writes the job control command. FIG. 10 illustrates the example in which the server apparatus 20 re-writes the commands C502 and C504 similarly to FIG. 9. In FIG. 10, for the user name, “Chen” is designated in the command C502 and a multi-byte character representing “Chen” is designated in the command C505. Also, for the user domain name, “unsupported domain name” is designated in the command C503, and characters shown in Expression (1) are designated in the command C506, as follows:

JADu= [symbol] (1)

where multi-byte characters represent China.

The second character of the multi-byte characters in Expression (1) is not expressed by Shift JIS. Hence, “unsupported domain name” is designated in the command C503, and the commands C503 and C506 indicate different meanings. For the document name, “Japanese version document” is designated in the commands C504 and C507.

In FIG. 10, the server apparatus 20 re-writes “Chen” designated in the command C502 into “Taro,” and transmits the command C602. The server apparatus 20 also re-writes “Japanese version document” designated in the command C504 into “revised version document,” and transmits the command C604.

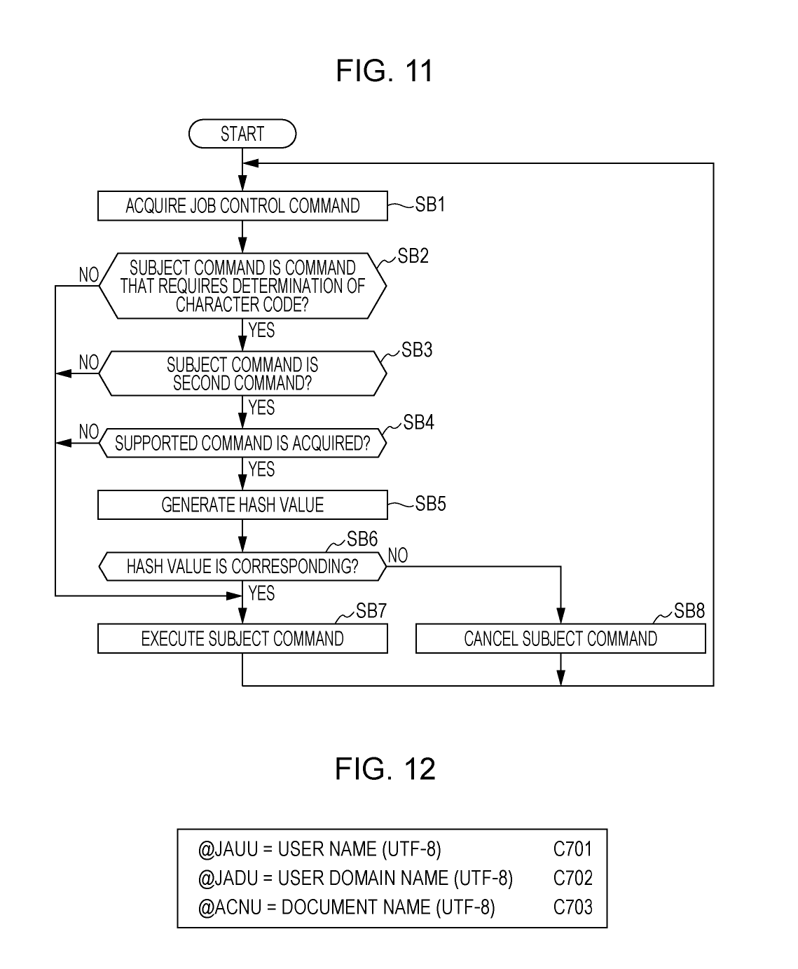

FIG. 11 is a flowchart showing processing when the image forming apparatus 30 acquires a job control command. The processing described below is repeated every time when the job control command is acquired. In step SB1, the controller 301 acquires a job control command from the server apparatus 20. Hereinafter, the job control command newly acquired in step SB1 is expressed as “subject command.” In step SB2, the controller 301 determines whether or not the subject command is a command that requires determination of the character code. The determination in step SB2 is made for executing a command that does not require determination of the character code. For example, a command not including a character other than a number, such as a command for designating the number of prints, is determined as a command that does not require determination of the character code. If the subject command is determined as a command that requires determination of the character code (YES in SB2), the controller 301 shifts the processing to step SB3. If the subject command is determined as a command that does not require determination of the character code (NO in SB2), the controller 301 shifts the processing to step SB7.

In step SB3, the controller 301 determines whether or not the subject command is the second command. If it is determined that the subject command is the second command (YES in SB3), the controller 301 shifts the processing to step SB4. If it is determined that the subject command is not the second command (NO in SB3), the controller 301 shifts the processing to step SB7.

In step SB4, the controller 301 determines whether or not the first command corresponding to the subject command (hereinafter, referred to as “corresponding command”) is acquired. To be specific, the correspondence between the first command and the second command (that is, information indicative of which first command a certain second command corresponds to) is previously registered in the image forming apparatus 30. The controller 301 specifies the corresponding command in accordance with the correspondence, and determines whether or not the corresponding command is acquired. The controller 301 determines whether or not the corresponding command is acquired within a predetermined time before the subject command is acquired. If it is determined that the subject command is acquired (YES in SB4), the controller 301 shifts the processing to step SB5. If it is determined that the corresponding command is not acquired (NO in SB4), the controller 301 shifts the processing to step SB7.

In step SB5, the controller 301 generates a hash value from the corresponding command. For example, as shown in FIGS. 9 and 10, if the subject command is the command C605, the controller 301 generates a hash value from the command C602. For another example, if the subject command is a command C606, the controller 301 generates a hash value from the command C603. For still another example, if the subject command is a command C607, the controller 301 generates a hash value from the command C604. The controller 301 stores the generated hash value in the RAM. In step SB6, the controller 301 determines whether or not the generated hash value corresponds to the hash value added to the subject command (for example, the hash values are the same). If it is determined that the two hash values correspond to each other (YES in SB6), the controller 301 shifts the processing to step SB7. If it is determined that the two hash values do not correspond to each other (NO in SB6), the controller 301 shifts the processing to step SB8.

In step SB7, the controller 301 executes the subject command. In step SB8, the controller 301 cancels the subject command.

In the example shown in FIG. 9 or 10, since the commands C601 to C604 are not the second command (NO in SB3), the commands C601 to C604 are executed. Since the command C605 is a command, in which the command C602 is re-written, the hash value generated from the command C602 does not correspond to the hash value added to the command C605 (hash value generated from the command C502) (NO in SB6). Hence, the command C605 is canceled. Since the command C606 is not the command obtained by re-writing the command C603, the hash value generated from the command C603 corresponds to the hash value added to the command C606 (YES in SB6). Hence, the command C606 is executed. Since the command C607 is the command obtained by re-writing the command C604, the hash value generated from the command C604 does not correspond to the hash value added to the command C607 (hash value generated from command C504) (NO in SB6). Hence, the command C607 is canceled.

With the above-described processing, if the server apparatus 20 re-writes the first command in the process of transmitting the job control command from the PC 10 to the image forming apparatus 30, the second command corresponding to the first command is canceled and the first command (the corresponding command of the second command) is executed. Hence, the second command, in which re-writing by the server apparatus 20 is not reflected, is executed, and a malfunction is prevented from occurring in the image forming apparatus 30.

The invention is not limited to the above-described exemplary embodiment, and various modifications may be made. Some modifications are described below. At least two of the modifications described below may be combined and used.

### (1) First Modification

The PC 10 may transmit the second command without transmitting the first command. In this case, the PC 10 may transmit the second command to which the hash value is not added.

FIG. 12 illustrates an example of a job control command according to a first modification. In FIG. 12, the PC 10 transmits the second command (commands C701 to C703) to which the hash value is not added. Even in the first modification, the image forming apparatus 30 may execute the processing shown in FIG. 11. In this case, the controller 301 determines that the corresponding command is not acquired in step SB4 in FIG. 11 (NO in SB4), and the subject command is executed. Also, in the first modification, if the server apparatus 20 acquires the second command from the PC 10, the server apparatus 20 may generate the first command corresponding to the second command, and transmit the first command and the second command to the image forming apparatus 30. In this case, the controller 301 executes the first command (step SB7). Also, in this case, since the hash value is not added to the second command, the controller 301 determines that the hash value does not correspond in step SB6 in FIG. 11 (NO in SB6), and the controller 301 cancels the second command.

### (2) Second Modification

In the image processing system 1, an image forming apparatus that does not support the extended character code may be used. The image forming apparatus that does not support the extended character code executes the first command, and cancels the second command. Even in this case, the PC 10 may execute the processing shown in FIG. 7.

### (3) Third Modification

In the image processing system 1, the server apparatus 20 may not be provided. Even in this case, the PC 10 may execute the processing shown in FIG. 7, and the image forming apparatus 30 may execute the processing shown in FIG. 11.

### (4) Fourth Modification

In the image processing system 1, a server apparatus that supports both the non-extended character code and the extended character code may be used. The server apparatus that supports both the non-extended character code and the extended character code may re-write the first command and the second command corresponding to the first command. Even in this case, the PC 10 may execute the processing shown in FIG. 7, and the image forming apparatus 30 may execute the processing shown in FIG. 11.

### (5) Fifth Modification

The character string generated from the first command is not limited to the hash value. The character string may be any type of data as long as the data is specific data derived from the first command. For example, binary data derived from the first command may be used as the character string.

### (6) Sixth Modification

The non-extended character code and the extended character code are not limited to the character codes described in the exemplary embodiment. For example, ASCII code or GB2312 code may be used as the non-extended character code.

### (7) Seventh Modification

The order of transmission of the first command and the second command is not limited to the order described in the exemplary embodiment. For example, the second command may be transmitted before the first command. In this case, in step SB4 in FIG. 11, the controller 301 waits for a predetermined time, and then determines whether or not the first command corresponding to the subject command is acquired. For another example, the first command and the second command may be alternately transmitted.

### (8) Eighth Modification

The PC 10 may transmit plural job control commands described in three or more character codes. For example, the PC 10 may transmit a job control command described in Shift JIS, a job control command described in GB2312, and a job control command described in Unicode.

### (9) Ninth Modification

The content described in the job control language is not limited to the contents shown in FIGS. 8 to 10. For example, additional information such as the number of prints or the created date and time of a document may be described in the job control language.

### (10) Tenth Modification

The job control command which is re-written by the server apparatus 20 is not limited to the command described in the exemplary embodiment. The server apparatus 20 may re-write, for example, the user domain name designated by the command C503. The server apparatus 20 may newly generate the first command and transmit the generated first command to the image forming apparatus 30.

### (11) Eleventh Modification

The information processing apparatus that transmits the rendering command and the job control command is not limited to the PC 10. For example, other information processing apparatus, such as a mobile phone or a tablet terminal, may transmit the rendering command and the job control command. Also, the information processing apparatus that processes the command transmitted from the PC 10 through the server apparatus 20 is not limited to the image forming apparatus 30. For example, instead of the image forming apparatus 30, an information processing apparatus that provides various services, such as output of data, storage of data, and conversion of data format may be used.

### (12) Twelfth Modification

The PC 10 may transmit the second command to which the hash value is added, and the second command to which the hash value is not added.

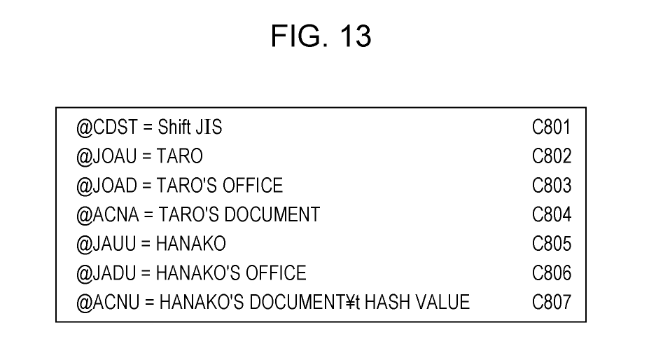

FIG. 13 illustrates an example of a job control command according to a twelfth modification. In FIG. 13, the PC 10 transmits the first command (commands C801 to C804) and the second command (commands C805 to C807). In the example in FIG. 13, the commands C805 and C806 are each the second command to which the hash value is not added, and the command C807 is the second command to which the hash value is added. In this example, the command C804 is the command which is not re-written by the server apparatus 20. In the twelfth modification, if the image forming apparatus 30 acquires the first command and the second command, and if the hash value is not added to the second command, the image forming apparatus 30 may execute one of the first command and the second command as an effective command according to a priority order previously determined for each command (for example, first priority and second priority at the timing when the image forming apparatus 30 acquires the job control command). The priority order is defined, for example, as the first priority in time series for the job control command indicative of the user name, the second priority in time series for the job control command indicative of the domain name, and the first priority in time series for the job control command indicative of the document name. In this example, the controller 301 determines that the job control command indicative of the user name is the first priority according to the priority order, and executes the command C802 as an effective command. In this example, the controller 301 determines that the job control command indicative of the domain name is the second priority according to the priority order, and executes the command C806 as an effective command. Further, the controller 301 determines that the job control command indicative of the document name corresponds to the hash value (YES in SB6), and the controller 301 executes the command C807.

### (13) Other Modification

The hardware configurations of the respective apparatuses used in the image processing system 1 are not limited to the configurations shown in FIGS. 4 to 6. The respective apparatuses may have any hardware configurations as long as the processing shown in FIGS. 7 and 11 is executed.

In the exemplary embodiment, the programs which are executed by the PC 10 and the image forming apparatus 30 may be provided in a form stored in a computer-readable recording medium, such as a magnetic recording medium (magnetic tape, magnetic disk (HDD, flexible disk (FD)), etc.), an optical recording medium (optical disk (compact disk (CD), digital versatile disk (DVD), etc.), a magneto-optical recording medium, or a semiconductor memory (flash ROM, etc.). Also, the programs may be downloaded through a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
an acquiring unit configured to acquire a first instruction and a second instruction, the second instruction corresponding to the first instruction, being expressed in a character code different from a character code of the first instruction, and having added thereto a first character string generated from the first instruction;
a generating unit configured to generate a second character string from the first instruction; and
a canceling unit configured to cancel the second instruction if the first character string does not correspond to the second character string.

2. The information processing apparatus according to claim 1, further comprising an executing unit configured to execute the second instruction if the first character string corresponds to the second character string.

3. The information processing apparatus according to claim 1, wherein the acquiring unit acquires the first instruction, which is re-written by an external apparatus, and the second instruction, which is not re-written by the external apparatus.

4. The information processing apparatus according to claim 1, wherein the first instruction and the second instruction indicate mutually different meanings.

5. The information processing apparatus according to claim 1, wherein the first character string and the second character sting are hash values.

6. An information processing apparatus comprising:
an instruction generating unit configured to generate a first instruction and a second instruction, the second instruction corresponding to the first instruction and being expressed in a character code different from a character code of the first instruction;
a generating unit configured to generate a character string from the first instruction; and
a transmitting unit configured to transmit the first instruction and the second instruction having added thereto the character string generated by the generating unit.

7. An information processing system comprising:
a first information processing apparatus including
an instruction generating unit configured to generate a first instruction and a second instruction, the second instruction corresponding to the first instruction and being expressed in a character code different from a character code of the first instruction,
a first generating unit configured to generate a first character string from the first instruction, and
a transmitting unit configured to transmit the first instruction and the second instruction having added thereto the first character string; and
a second information processing apparatus including
an acquiring unit configured to acquire the first instruction and the second instruction transmitted by the transmitting unit,
a second generating unit configured to generate a second character string from the first instruction, and
a canceling unit configured to cancel the second instruction if the first character string does not correspond to the second character string.

8. An information processing method comprising:
acquiring a first instruction and a second instruction, the second instruction corresponding to the first instruction, being expressed in a character code different from a character code of the first instruction, and having added thereto a first character string generated from the first instruction;
generating a second character string from the first instruction; and
canceling the second instruction if the first character string does not correspond to the second character string.

9. An information processing method comprising:
generating a first instruction and a second instruction, the second instruction corresponding to the first instruction and being expressed in a character code different from a character code of the first instruction;
generating a character string from the first instruction; and
transmitting the first instruction and the second instruction having added thereto the generated character string.

10. A non-transitory computer readable medium storing a program causing a computer to execute a process for image processing, the process comprising:
acquiring a first instruction and a second instruction, the second instruction corresponding to the first instruction, being expressed in a character code different from a character code of the first instruction, and having added thereto a first character string generated from the first instruction;
generating a second character string from the first instruction; and
canceling the second instruction if the first character string does not correspond to the second character string.

11. A non-transitory computer readable medium storing a program causing a computer to execute a process for image processing, the process comprising:
generating a first instruction and a second instruction, the second instruction corresponding to the first instruction and being expressed in a character code different from a character code of the first instruction;
generating a character string from the first instruction; and
transmitting the first instruction and the second instruction having added thereto the generated character string.

12. The information processing apparatus according to claim 1, further comprising an executing unit configured to execute the first instruction if the second instruction is canceled.
